(19) United States
(12) Patent Application Publication
(10) Pub. No.: US 2009/0222928 A1
(43) Pub. Date: Sep. 3, 2009

(54) IMAGE PROCESSING APPARATUS, INFORMATION PROCESSING METHOD, AND COMPUTER PROGRAM PRODUCT

(76) Inventor: Takanori YANO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/366,212

(22) Filed: Feb. 5, 2009

(30) Foreign Application Priority Data
Feb. 28, 2008 (JP) 2008-048562

(51) Int. Cl. G06F 21/04

(52) U.S. Cl. 726/26

(57) ABSTRACT

An identification-information obtaining unit obtains identification information for identifying a module to be customized. A validating unit validates, based on validation information including information indicating whether to allow a customization for a module identified by the identification information, whether the module identified by the identification information is customizable. When the validating unit validates that the module identified by the identification information is customizable, a control unit performs the customization of the module identified by the identification information.

### CROSS-REFERENCE TO RELATED APPLICATIONS

The present application claims priority to and incorporates by reference the entire contents of Japanese priority document 2008-048562 filed in Japan on Feb. 28, 2008.

### BACKGROUND OF THE INVENTION

1. Field of the Invention

The present invention relates to a technology for customizing software program modules in an image processing apparatus.

2. Description of the Related Art

Typically, a multifunction product (MFP) has various applications installed in it. In recent years, the software programs for such applications are configured from processing units that are smaller in size than processing modules. Modifications in such small processing units facilitate in providing flexible services according to user demands.

If an MFP is connected to a personal computer (PC) via a network, then software programs in the MFP are customizable from the PC. Consequently, it is possible to perform software customization according to user demands and provide flexible services to the users.

However, conventionally, software customization of an MFP is restricted to its administrator having customization rights. In that case, it is not possible for a user to independently customize a software program.

Actually, by allowing software customization by user, applications of the MFP can be easily modified to suit one's purpose. Thus, it is not entirely desirable to restrict software customization to an administrator.

In the case of allowing software customization by user, it is first necessary to validate the users. Japanese Patent Application Laid-open No. 2004-5408 discloses a technique to validate the users of an MFP.

However, such validation is performed only with respect to the users and cannot be implemented for software programs that are to be customized.

More particularly, some of the software programs in an MFP use classified data such as private information of the users or critical information. Thus, to protect such classified data, it is necessary to validate each software program for customization instead of validating the users. Such a feature helps in determining the software programs that are allowed to be customized and software programs that are not allowed to be customized.

### SUMMARY OF THE INVENTION

It is an object of the present invention to at least partially solve the problems in the conventional technology.

According to one aspect of the present invention, there is provided an image processing apparatus including a module to be customized; an identification-information obtaining unit that obtains identification information for identifying the module; a validating unit that validates, based on validation information including information indicating whether to allow a customization for a module identified by the identification information, whether the module identified by the identification information is customizable; and a control unit that, when the validating unit validates that the module identified by the identification information is customizable, performs the customization of the module identified by the identification information.

Furthermore, according to another aspect of the present invention, there is provided an image processing method including obtaining identification information for identifying a module to be customized; validating, based on validation information including information indicating whether to allow a customization for a module identified by the identification information, whether the module identified by the identification information is customizable; and performing, when the module identified by the identification information is validated to be customizable at the validating, the customization of the module identified by the identification information.

Moreover, according to still another aspect of the present invention, there is provided a computer program product including a computer-usable medium having computer-readable program codes embodied in the medium. The program codes when executed cause a computer to execute obtaining identification information for identifying a module to be customized; validating, based on validation information including information indicating whether to allow a customization for a module identified by the identification information, whether the module identified by the identification information is customizable; and performing, when the module identified by the identification information is validated to be customizable at the validating, the customization of the module identified by the identification information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an exemplary configuration of an MFP according to a first embodiment of the present invention;

FIG. 2 is a diagram for explaining an exemplary modular configuration of an application installed in the MFP;

FIG. 3 is a diagram of an exemplary hardware configuration of the MFP;

FIG. 4 is a diagram for explaining an exemplary network configuration of a network to which the MFP is connected;

FIG. 5 is a block diagram of an exemplary configuration of an MFP activating device in the MFP;

FIG. 6 is a diagram for explaining a validation process performed by a certification control service (CCS) in the MFP;

FIG. 7 is a diagram of an exemplary table structure of a program information documents data base (program IDDB) in the MFP;

FIG. 8 is a diagram for explaining the concept of a validation file;

FIG. 9 is a flowchart for explaining a process from activating the MFP to updating a module;

FIG. 10 is a flowchart for explaining a process by which a program activating unit in the MFP activates control services and application programs;

FIG. 11 is a flowchart for explaining a process by which a read only memory (ROM) updating application program in the MFP stores update data;

FIG. 12 is a diagram of an exemplary update data area in which the ROM updating application program stores update data;

FIG. 13 is a flowchart for explaining a process by which a system control service (SCS) selects update data and issues a ROM updating command;

FIG. 14 is a flowchart for explaining another process by which the SCS selects update data and issues a ROM updating command;

FIG. 15 is a flowchart for explaining a validation process performed by the CCS;

FIG. 16 is a flowchart for explaining another validation process performed by the CCS;

FIG. 17 is a flowchart for explaining a process by which a ROM updating unit updates a flash memory;

FIG. 18 is a diagram for explaining an exemplary network configuration according to a second embodiment of the present invention of the network to which the MFP is connected;

FIG. 19 is a diagram for explaining a validation process performed by the CCS according to the second embodiment;

FIG. 20 is a diagram of an exemplary address of a validation server included in validation setting information according to the second embodiment;

FIG. 21 is a diagram of an exemplary data structure of data in a simple object access protocol (SOAP) message generated for transmission by a SOAP proxy according to the second embodiment;

FIG. 22 is a diagram of an exemplary structure of a SOAP message generated by the SOAP proxy; and

FIG. 23 is a sequence diagram for explaining a sequence in which the validation server performs a validation process.

### DETAILED DESCRIPTION OF THE PREFERRED EMBODIMENTS

Exemplary embodiments of the present invention are described in detail below with reference to the accompanying drawings. The present invention is not limited to these exemplary embodiments. More particularly, although the exemplary embodiments are given with reference to an MFP including an image processing apparatus, the exemplary embodiments are also applicable to any other image processing apparatus.

The description below is given with reference to an MFP 100 that performs various functions of copying, facsimile (FAX), printing, scanning, distribution of input image (e.g., an image scanned from an original or an image input from a printer or a facsimile unit), and the like.

A Module or a sub-module in the MFP 100 can be subjected to validation with the use of two validation methods. The first validation method is a local validation method in which the MFP 100 itself performs the validation, while the second validation method is a remote validation method in which a validation server (e.g., a network (NT) server or a lightweight directory access protocol (LDAP) server) connected to the MFP 100 via a network is requested to perform the validation. Given below is the description of the local validation method according to a first embodiment of the present invention.

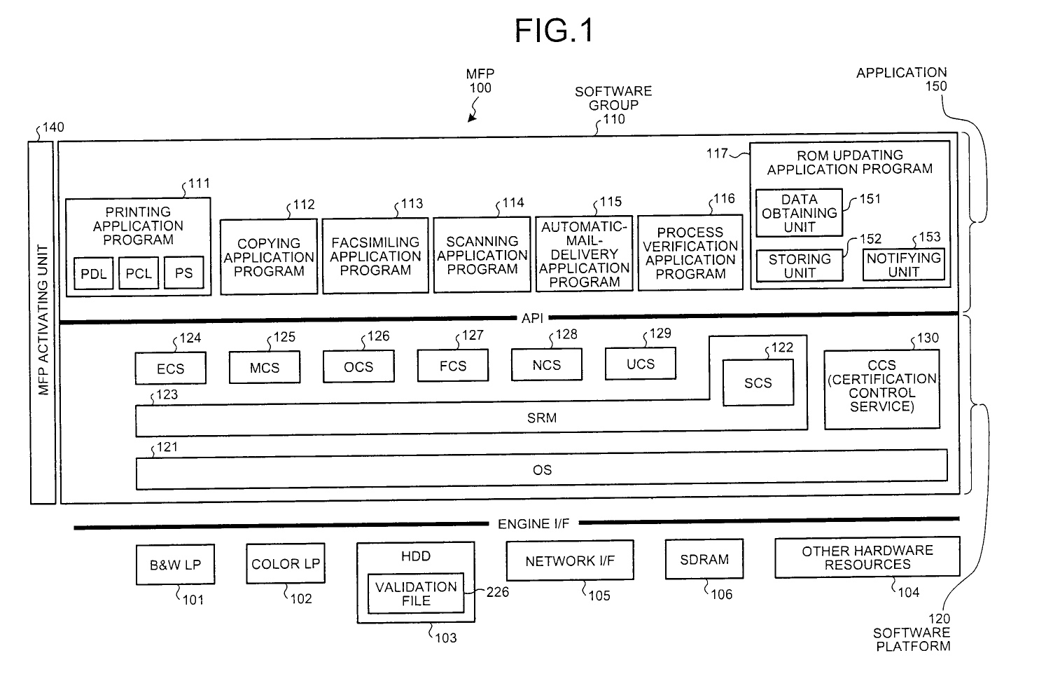

First, an exemplary configuration of the MFP 100 according to the first embodiment is described with reference to FIG. 1.

As shown in FIG. 1, the MFP 100 includes a black-and-white line printer (B&W LP) 101, a color line printer (color LP) 102, a hard disk drive (HDD) 103, a network interface (I/F) 105, a synchronous dynamic random access memory (SDRAM) 106, other hardware resources 104 (e.g., a scanner, a facsimile unit, and a memory), and a software group 110. The software group 110 includes a software platform 120 and an application 150.

The software platform 120 includes a variety of control services, a system resource manager (SRM) 123, and an operating system (OS) 121. A control service interprets a processing request from the application 150 and generates a resource acquisition request regarding a hardware resource. The SRM 123 manages one or more hardware resources and arbitrates the resource acquisition requests generated by the control services.

The control services are service modules, namely, an SCS 122, an engine control service (ECS) 124, a memory control service (MCS) 125, an operation-panel control service (OCS) 126, a facsimile control service (FCS) 127, a network control service (NCS) 128, a user-information control service (UCS) 129, and a CCS 130.

The software platform 120 also includes an application program interface (API) that is programmed to receive processing requests from the application 150 by using predetermined functions.

The OS 121 is a general purpose OS such as UNIX (registered trademark) that can parallely execute software programs from the software platform 120 and the application 150 as processes.

The SRM 123 is configured to perform a process of system control and resource management along with the SCS 122. For example, if a request is issued by a higher-level layer that uses a hardware resource such as an engine, a memory, an HDD file, or a host input/output (I/O) (e.g., a Centronics I\F, a network I\F, an IEEE1394 I\F, or an RS232C I\F) of a scanning unit or a printing unit, then the process of the SRM 123 performs resource arbitration and execution control based on the issued request.

More particularly, the SRM 123 determines whether the hardware resource requested by the higher-level layer is available (i.e., whether the requested hardware resource is being allocated for another request). If the requested hardware resource is available, then the SRM 123 notifies the higher-level layer about the availability of the requested hardware resource. Moreover, the SRM 123 also performs usage scheduling of the hardware resource requested by the higher-level layer. For example, the SRM 123 instructs a printer engine to execute an operation such as paper conveyance, image formation, memory allocation, or file generation according to a request from the higher-level layer.

The SCS 122 is configured to perform a process of application management, operating unit control, system screen display, light emitting diode (LED) display, resource management, and interrupt application control.

The ECS 124 is configured to perform a process of engine control of hardware resources such as the B&W LP 101, the color LP 102, the HDD 103, a scanning unit, and a facsimile unit.

The MCS 125 is configured to perform a process of allocation/deallocation of image memory, HDD utilization, and compression/expansion of image data.

The OCS 126 is configured to control an operation panel 170 that functions as a communication tool between the operator (user) of the MFP 100 and the control system of the MFP 100. The OCS 126 includes an OCS process portion and an OCS library portion. The OCS process portion obtains a key press (or a touch operation) on the operation panel 170 as a key event and sends a key event function corresponding to that key event to the SCS 122. The OCS library portion includes a library in which functions such as a screen output function for outputting various screens or control functions with respect to the operation panel 170 are registered in advance.

The OCS library is maintained linked to the modules in the application 150 and in the control services. Meanwhile, the OCS 126 can be entirely configured to function as OCS processes or can be entirely configured to be the OCS library.

The FCS 127 is configured to perform a process of providing applications for facsimile transmission/facsimile reception with each application layer of the system controller via a public switched telephone network (PSTN) or an integrated services digital network (ISDN), registration/extraction of facsimile data stored in a backup static random access memory (BKM), reading of facsimile data, printing of received facsimiles, and integrated transmission/reception.

The NCS 128 is configured to perform a process of providing sharable services to application programs such as a scanning application program 114 that is installed in the MFP 100 and that requires a network I/O. More particularly, the NCS 128 performs intermediary processing of allocating data received from a network to an application program or sending data from an application program to the network.

The UCS 129 is configured to perform a process of referring to a user database (not shown) and managing user information of users of the MFP 100. More particularly, the UCS 129 determines the memory unit in which user information corresponding to a particular request is stored, obtains the user information from that memory unit, and sends the user information to an application program.

The CCS 130 is configured to perform a process of validating modules or sub-modules for customization by referring to a validation file 226 stored in the HDD 103. The configuration of the CCS 130 is described later in detail.

The application 150 includes a plurality of application programs, namely, a printing application program 111, a copying application program 112, a facsimileing application program 113, the scanning application program 114, an automatic-mail-delivery application program 115, a process verification application program 116, and a ROM updating application program 117.

Among those application programs, the printing application program 111, the copying application program 112, the facsimileing application program 113, the scanning application program 114, the automatic-mail-delivery application program 115, and the process verification application program 116 are the application programs that can be subjected to customization.

In the MFP 100, more than one module is installed in the application 150. When a user decides to customize the application 150, the CCS 130 determines whether to validate each module in the application 150 for customization and, based on validation results, controls the customization of the modules.

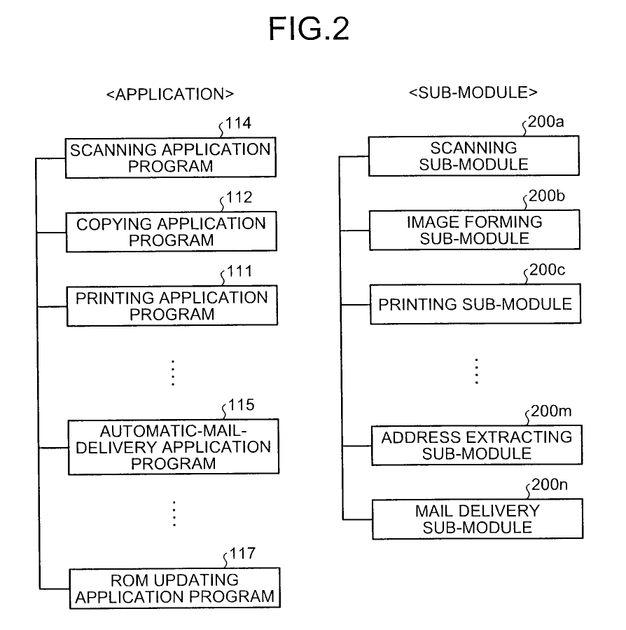

Herein, an independent and partitionable software unit (application program) in the application 150 is considered as a module. FIG. 2 is a diagram for explaining an exemplary modular configuration of the application 150. In the application 150, each of the independent application programs (111 to 115) is configured from a combination of sub-modules 200a to 200n.

Similar to the application programs in the application 150, each control service in the software platform 120 is also a module (service module) configured from a combination of sub-modules.

Meanwhile, instead of performing the validation for modules or sub-modules, it is also possible to perform the validation for further smaller software units. Even in that case, the local validation method can be implemented.

In the modular configuration shown in FIG. 2, a sub-module such as an address extracting sub-module 200m uses an address book that contains, e.g., private information of the users. Hence, to protect the private information, it is necessary to restrict customization of the address extracting sub-module 200m.

Reverting to FIG. 1, the ROM updating application program 117 is an application program that is configured to update a ROM in which modules or sub-modules are stored, and that includes a data obtaining unit 151, a storing unit 152, and a notifying unit 153. The ROM updating application program 117 can update the ROM and the application 150 in a remote manner.

The data obtaining unit 151 obtains update data used for customization (update) and module IDs (or sub-module IDs) used for identification of modules (or sub-modules) that are to be customized.

The storing unit 152 stores the update data of the identified modules (or the identified sub-modules) in the SDRAM 106.

The notifying unit 153 notifies the SCS 122 about the storage of the update data in the SDRAM 106. Subsequently, the SCS 122 starts updating ROM data.

Meanwhile, the MFP 100 includes an MFP activating unit 140 that, when the MFP 100 is switched ON, controls the operations of the software group 110 and activates the MFP 100 to a usable state. The configuration of the MFP activating unit 140 is described later in detail.

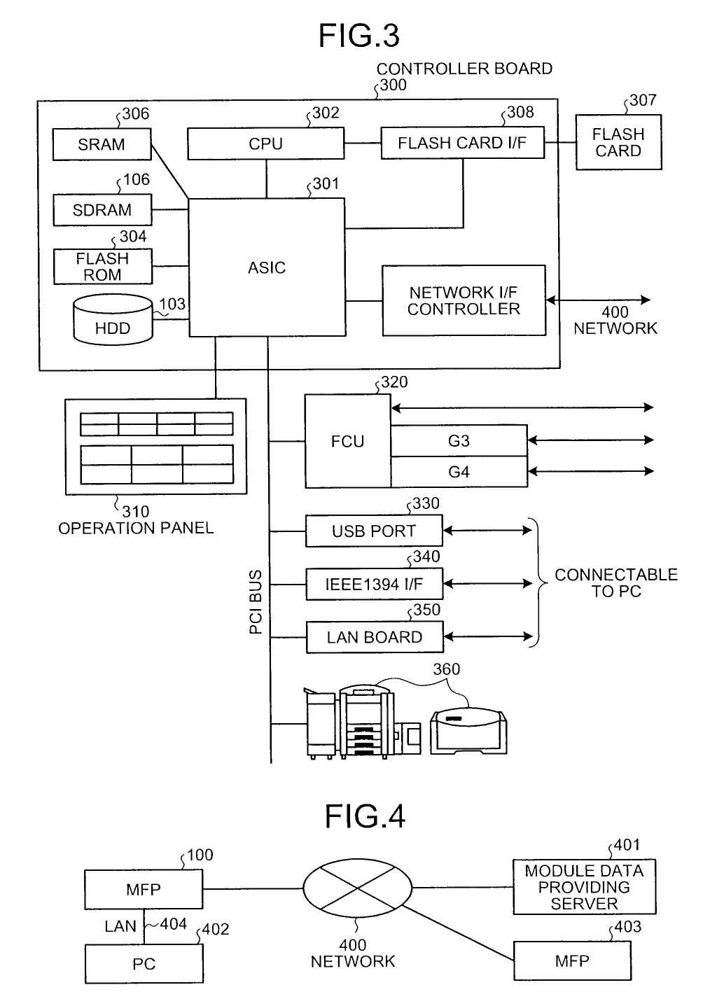

FIG. 3 is a diagram of an exemplary hardware configuration of the MFP 100. As shown in FIG. 3, the MFP 100 includes a controller board 300, an operation panel 310, a fax control unit (FCU) 320, a universal serial bus (USB) port 330, a local area network (LAN) board 350 (compatible to 100BASE-TX/100BASE-T or wireless LAN), an IEEE1394 I/F 340, and a printer 360. In the controller board 300, a central processing unit (CPU) 302, the SDRAM 106, a static random access memory (SRAM) 306, a flash memory 304 (hereinafter, “flash ROM 304”), a flash card I/F 308, and the HDD 103 are connected to an application specific integrated circuit (ASIC) 301. The operation panel 310 is directly connected to the ASIC 301, while the FCU 320, the USB port 330, the IEEE1394 I/F 340, the LAN board 350, and the printer 360 are connected to the ASIC 301 via a peripheral component interconnect (PCI) bus.

The flash ROM 304 is used to store the application programs in the application 150, the control services in the software platform 120, and programs in the SRM 123 at the time of product shipment.

The SRAM 306 is used to store information about the environment in which the programs are executed (e.g., a mode flag).

The USB port 330, the IEEE1394 I/F 340, or the LAN board 350 can be used to connect the MFP 100 to a PC.

Thus, in addition to a customization request issued directly from the operation panel 310, the MFP 100 can receive a customization request issued from a connected PC. FIG. 4 is a diagram for explaining an exemplary network configuration of a network 400 to which the MFP 100 is connected. Apart from the MFP 100, a module data providing server 401 and an MFP 403 are also connected to the network 400. A PC 402 is connected to the MFP 100 via a LAN 404.

A customization request issued by a user from the PC 402 is sent to the MFP 100.

The module data providing server 401 provides update data of the modules (or the sub-modules) to be customized.

The module data providing server 401 is used to store the update data corresponding to various types of modules (or sub-modules). For example, some of the update data may correspond to the modules (or the sub-modules) that can be freely accessed by a user with login rights for the module data providing server 401. On the other hand, some of the update data may correspond to the modules (or the sub-modules) that use classified data such as private information of the users or critical information. The update data of such modules (or sub-modules) is restricted from being provided to the MFP 100.

Upon receiving a customization request (e.g., an update request) from the PC 402 via the LAN 404, the MFP 100 loads a software customization function from the module data providing server 401 via the network 400 and stores it in a flash memory (flash ROM). In this way, the MFP 100 prepares itself for customization of an application program based on a customization request from a remote PC.

Meanwhile, in the following description, although updating an application program is implemented as an example of customization, it is also possible to implement other customization functions.

The MFP 100 has validation functionality with respect to an update request received from a remote source via the network 400. Thus, depending on the module type (or sub-module type), it is possible for the MFP 100 to restrict updating particular module types (or sub-module types) by the corresponding update data.

After switching ON the MFP 100, a module (or a sub-module) is updated when the MFP activating unit 140 activates the MFP 100. Given below is the detailed description of the MFP activating unit 140.

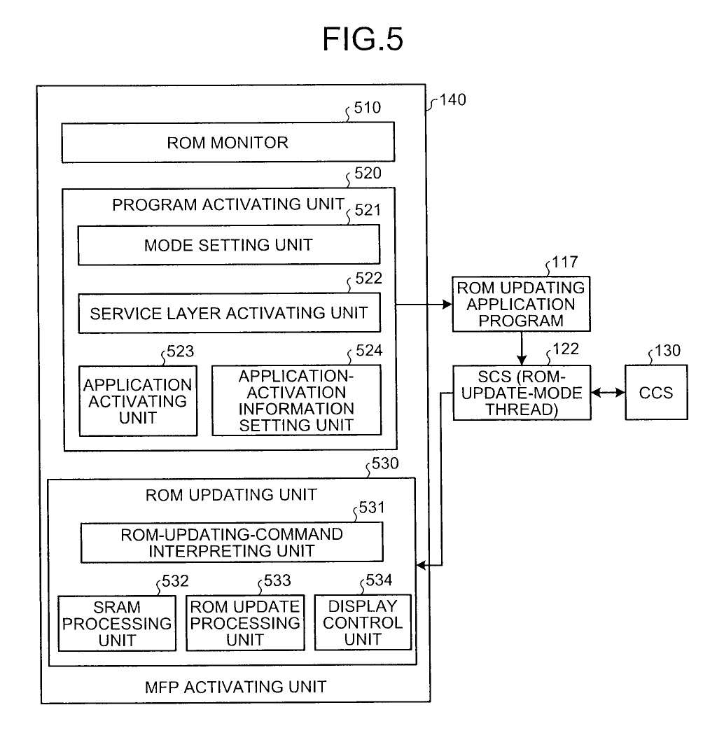

FIG. 5 is a block diagram of an exemplary configuration of the MFP activating unit 140. The MFP activating unit 140 includes a ROM monitor 510, a program activating unit 520, and a ROM updating unit 530.

The MFP activating unit 140 functions when the MFP 100 is switched ON, and activates control units and applications of the MFP 100.

The ROM monitor 510 is stored in the boot vector of the flash ROM 304 and is loaded firstly after switching ON the MFP 100.

The ROM monitor 510 can be loaded by either one of an external load command issued from outside of the MFP 100 and an internal load command issued from inside the MFP 100. For example, the load command for the ROM monitor 510 can be issued when the MFP 100 is remotely restarted after it receives data packets of update data corresponding to a module via a network and stores those data packets.

Upon loading, the ROM monitor 510 performs functions such as hardware initialization, control board diagnosis, software initialization, and booting of the OS 121.

The program activating unit 520 includes a mode setting unit 521, a service layer activating unit 522, an application activating unit 523, and an application-activation information setting unit 524.

The program activating unit 520 gets activated when invoked by the OS 121, and then activates the application 150 or the software platform 120 as necessary.

More particularly, e.g., the kernel of the OS 121 can also be used as the program activating unit 520. In that case, as soon as the OS 121 boots, the program activating unit 520 is activated and a root file system is built therein. Subsequently, the file system regarding the application 150 and the software platform 120 are mounted on the root file system whereby programs in the application 150 and the software platform 120 start to run.

The functioning of the program activating unit 520 is determined by the mode in which it is activated. That is, the program activating unit 520 is activated in two activation modes, namely, a normal mode and a ROM update mode. In the normal mode of the program activating unit 520, the MFP 100 is activated to perform normal functions such as copying, printing, scanning, and facsimile. In the ROM update mode of the program activating unit 520, the MFP 100 is activated to update the flash ROM 304.

When the program activating unit 520 is activated in the ROM update mode, the modules (or the sub-modules) in the flash ROM 304 are updated based on the update data stored in an HDD or a memory card, or the update data provided via a network.

Based on the mode flag stored in the SRAM 306, the mode setting unit 521 sets the mode of the program activating unit 520 to either one of the normal mode and the ROM update mode. The program activating unit 520 is loaded according to the mode set by the mode setting unit 521.

The service layer activating unit 522 obtains booting information of the OS 121 and activates the control services.

The application-activation information setting unit 524 functions when the activation mode is the ROM update mode, obtains activation information regarding each application program, and sets the activation information in environment variables.

The application activating unit 523 activates the applications in both activation modes. For example, when the activation mode is the ROM update mode, the application activating unit 523 obtains activation information regarding the ROM updating application program 117 and then activates the ROM updating application program 117. Consequently, the ROM updating application program 117, the SCS 122, and the CCS 130 perform the respective processing. Eventually, the ROM updating unit 530 updates the flash ROM 304.

On the other hand, when the activation mode is the normal mode, the application activating unit 523 obtains activation information regarding each application and activates each application.

The ROM updating unit 530 includes a ROM-updating-command interpreting unit 531, an SRAM processing unit 532, a ROM update processing unit 533, and a display control unit 534.

The ROM-updating-command interpreting unit 531 interprets a ROM updating command issued from the SCS 122.

The ROM update processing unit 533 updates programs in the flash ROM 304 based on an update-destination address and the ROM updating command.

The SRAM processing unit 532 stores all information during the ROM update in the SRAM 306.

The display control unit 534 controls the user display showing the progress in the ROM update progressing.

If the application activating unit 523 is activated when the activation mode is the ROM update mode, then the ROM updating application program 117 is activated at the last. After the ROM updating application program 117 obtains the update data, the SCS 122 starts the processing. That is, the SCS 122 invokes the CCS 130 for performing validation process. Given below is the detailed description of the CCS 130.

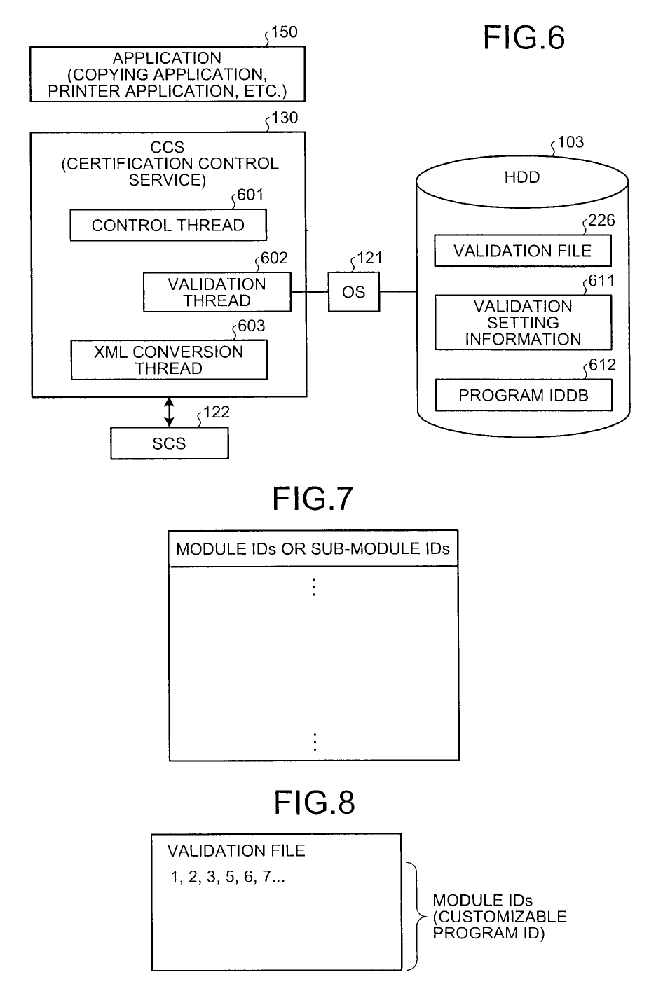

FIG. 6 is a diagram for explaining the validation process performed by the CCS 130. The validation process performed by the CCS 130 includes a control thread 601, a validation thread 602, and an extensible markup language (XML) conversion thread 603. During the validation process, the CCS 130 validates each module (or each sub-module) for customization, converts the validation result for each module into XML format, and stores the validation result in XML format as the validation file 226 in the HDD 103.

In addition to the validation file 226, the HDD 103 is used to store validation setting information 611 and a program IDDB 612.

The validation setting information 611 includes information regarding a validation processing unit and a validation method. The validation processing unit can be the body of the validation thread 602 or a validating server connected to the MFP 100 via the network 400. The validation method can be either one of a known validation method and an original validation method. In the first embodiment, the validation setting information 611 includes notification that the validation thread 602 performs validation by referring to the program IDDB 612 stored in the HDD 103.

The program IDDB 612 is used to store module IDs (or sub-module IDs) used for identifying modules (or sub-modules) to be validated for customization. FIG. 7 is a diagram of an exemplary table structure of the program IDDB 612 in which module IDs (or sub-module IDs) are stored.

The module IDs (or sub-module IDs) of modules (or sub-modules) that use an address book containing address information of the users are also stored in the program IDDB 612. Such modules and sub-modules are restricted from customization to protect the classified data (private information or critical information).

Reverting to FIG. 6, the control thread 601 controls various functions of the CCS 130. For example, upon receiving a validation request from a program of the SCS 122, the control thread 601 generates the validation thread 602 and the XML conversion thread 603, and instructs those threads to perform their respective processing. The control thread 601 also performs selection of a validation method and transmission/reception of information during the inter-process communication in the SCS 122. Moreover, the control thread 601 can be configured to set the validation setting information 611.

The validation thread 602 reads the validation setting information 611 from the HDD 103 and validates the modules (or the sub-modules) with the validation method specified in the validation setting information 611.

With respect to the CCS 130, the SCS 122 performs processes such as request for initialization setting and display of a validation screen during the validation process.

During the validation process, first, the validation thread 602 determines a validation method by referring to the validation setting information 611.

Subsequently, by implementing the determined validation method, the validation thread 602 compares the module IDs (or the sub-module IDs) of the modules (or the sub-modules) specified in an update request and the module IDs (or the sub-module IDs) stored in the program IDDB 612, validates each module (or each sub-module) for update, and generates a validation result (e.g., validation successful, validation failed) for each module (or each sub-module).

Then, the XML conversion thread 603 converts the validation result for each module (or each sub-module) into XML format and stores the validation result in XML format as the validation file 226 in the HDD 103. The validation results can be converted into XML format with any known conversion method.

FIG. 8 is a diagram for explaining the concept of the validation file 226. In the validation file 226 shown in FIG. 8, the module IDs (or the sub-module IDs) of the modules (or the sub-modules) validated for customization are listed in XML format. The validation file 226 is referred to at the time of customizing (updating) an application program on a module basis.

In this way, while updating an application program in the MFP 100, the stored validation file 226 can be used for cross-checking. Meanwhile, updating the validation file 226 or cross-checking with the use of the updated validation file 226 is not limited at the time of activating the MFP 100. In other words, updating the validation file 226 or cross-checking with the use of the updated validation file 226 can be performed at any arbitrary timing.

In the first embodiment, users of the MFP 100 that issue customization requests are not identified. However, it is also possible to update the validation file 226 separately with respect to each user.

By referring to the validation file 226, the ROM updating unit 530 can update the flash ROM 304 regarding each module (or each sub-module).

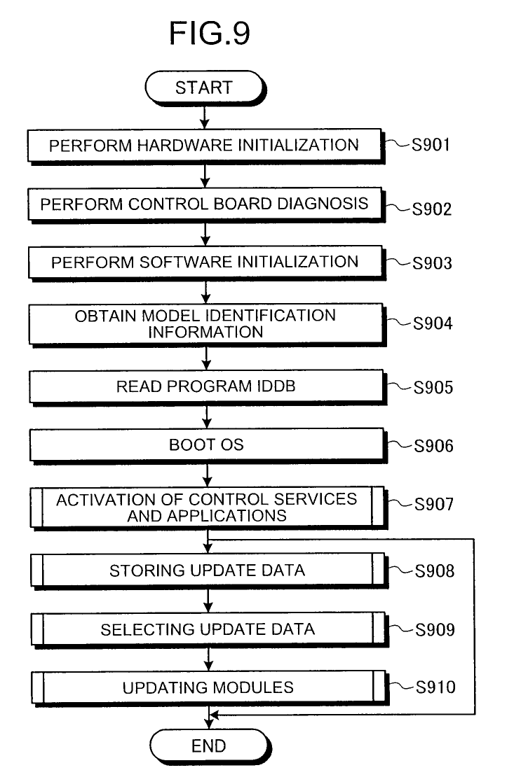

FIG. 9 is a flowchart for explaining the process from activating the MFP 100 to updating a module (or a sub-module).

First, the ROM monitor 510 in the MFP activating unit 140 performs hardware initialization (Step S901).

Then, the ROM monitor 510 performs control board diagnosis (Step S902) and software initialization (Step S903).

The ROM monitor 510 obtains model identification information from the flash ROM 304 (Step S904). The model identification information is for identifying a model of an MFP, which is unique data for each model.

The validation thread 602 reads the module IDs (or the sub-module IDs) from the program IDDB 612 stored in the HDD 103 (Step S905). The read modules IDs (or sub-module IDs) are stored in the validation file 226 corresponding to the model identification information specified in the flash ROM 304.

The ROM monitor 510 then boots the OS 121 (Step S906).

The OS 121 activates the program activating unit 520, which then activates the control services and the applications (Step S907). The ROM updating application program 117 is activated only in the case of updating the ROM. Otherwise, the process is completed.

When activated, the ROM updating application program 117 stores the update data for ROM update in the SDRAM 106 (Step S908).

From the stored update data, the SCS 122 selects the update data to be used (Step S909). For that, the SCS 122 validates the update data by using module IDs (or the sub-module IDs) stored in the validation file 226.

The ROM updating unit 530 then updates the modules (or the sub-modules) with the corresponding selected update data (Step S910).

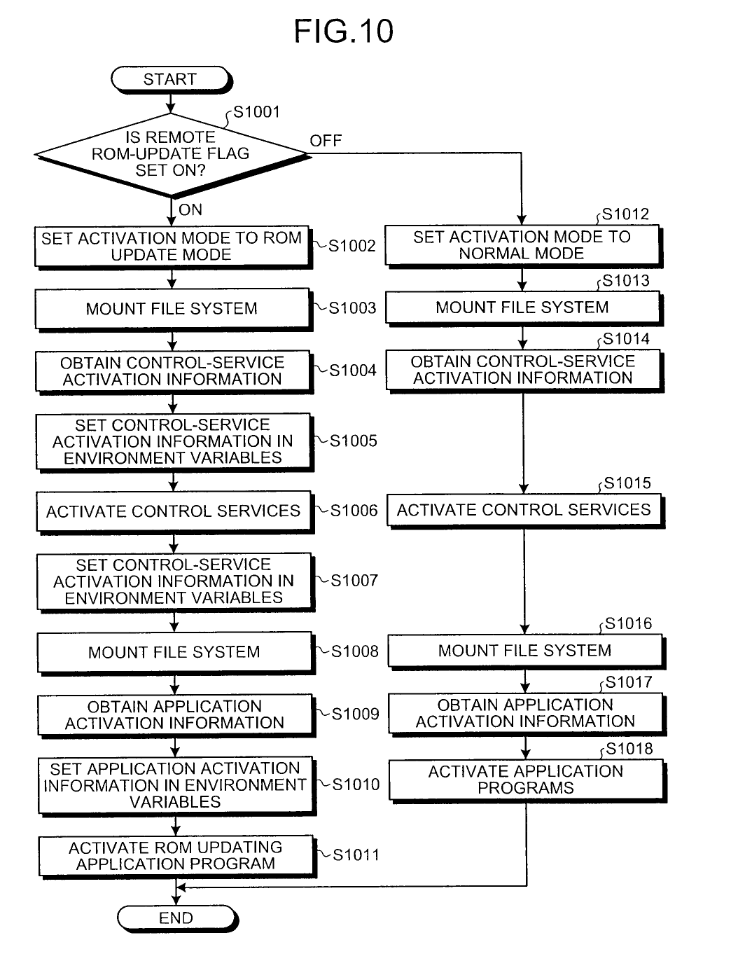

FIG. 10 is a flowchart for explaining in detail the process of activating the control services and the application programs stated at Step S907.

The mode setting unit 521 in the program activating unit 520 checks the status of a remote ROM-update flag stored in the SRAM 306 (Step S1001).

The remote ROM-update flag is set ON before temporarily shutting down the MFP 100 for restart. During an activated state of the MFP 100, when the NCS 128 receives an update request from the PC 402 or the module data providing server 401, it sends an MFP restart request to the SCS 122. The SCS 122 then sets ON the remote ROM-update flag in the SRAM 306 and issues an MFP restart command such that the MFP 100 restarts. Thus, the remote ROM-update flag remains ON when the MFP 100 is temporarily shut down for restart. However, at the time of switching OFF the MFP 100, the remote ROM-update flag is set OFF.

When the remote ROM-update flag is set ON (ON at Step S1001), the mode setting unit 521 loads the program activating unit 520 in the ROM update mode (Step S1002).

Subsequently, the service layer activating unit 522 mounts the file system from the flash ROM 304 (Step S1003) and obtains control-service activation information regarding the control services such as the SCS 122, the ECS 124, the MCS 125, and the CCS 130 from the flash ROM 304 (Step S1004). The control-service activation information regarding the CCS 130 includes the validation file 226, the program IDDB 612, and the validation setting information 611.

The service layer activating unit 522 sets the obtained control-service activation information in environment variables (Step S1005).

The service layer activating unit 522 then activates the SCS 122, the ECS 124, the MCS 125, and the CCS 130 on the OS 121 (Step S1006). At that time, a ROM-update-mode thread is started in each control service (including the SCS 122). In the CCS 130, the control thread 601, the validation thread 602, and the XML conversion thread 603 are also started.

After the ROM-update-mode thread in the SCS 122 is started, the service layer activating unit 522 sets the control-service activation information of the activated control services in environment variables (Step S1007).

The control-service activation information is program identification information of each control service and includes information such as process IDs of processes or module names of modules in each control service.

The application-activation information setting unit 524 then mounts the file system from the flash ROM 304 (Step S1008).

The application-activation information setting unit 524 searches for application programs stored in the file system, extracts the application programs, and obtains application activation information of the activated application programs in the MFP 100 (Step S1009).

The application-activation information setting unit 524 then sets the application activation information in environment variables (Step S1010).

The application activation information is identification information of application programs that are executable in the MFP 100 and includes information such as module IDs or module names of modules in each application program. The control-service activation information as well as the application activation information is sent to the SCS 122. However, in the ROM update mode of the program activating unit 520, application activation information of only the ROM updating application program 117 is sent to the SCS 122.

The application activating unit 523 then activates the ROM updating application program 117 (Step S1011). The control-service activation information is sent to control services of the SCS 122, while the application activation information is sent to application programs of the SCS 122. When the activation mode is the ROM update mode, applications other than the ROM updating application program 117 are not activated.

Reverting to Step S1001, when the remote ROM-update flag is set OFF (OFF at Step S1001), the mode setting unit 521 sets the activation mode to the normal mode (Step S1012).

Subsequently, the service layer activating unit 522 mounts the file system from the flash ROM 304 (Step S1013).

The service layer activating unit 522 obtains the control-service activation information regarding the control services such as the SCS 122, the ECS 124, and the MCS 125 from the flash ROM 304 (Step S1014).

The service layer activating unit 522 then activates the SCS 122, the ECS 124, and the MCS 125 on the OS 121 (Step S1015). At that time, a normal mode thread is started in each activated control service.

Subsequently, the application activating unit 523 mounts the file system from the flash ROM 304 (Step S1016).

Then, the application activating unit 523 obtains the application activation information executable in the MFP 100 from the mounted file system (Step S1017).

Finally, the application activating unit 523 activates the application programs (Step S1018). However, the ROM updating application program 117 is not activated at Step S1018.

As described above, the ROM updating application program 117 is activated at Step S1011. When the ROM updating application program 117 completes the update processing, the modules (or the sub-modules) for which an update request is issued are validated for customization. Subsequently, only the validated modules of service layer programs or the validated modules of application programs are subjected to customization.

If the CCS 130 is also to be customized, then that customization is carried out first. As a result, the modules of service layer programs or the modules of application programs can be validated by using the customized CCS 130.

In the case of remote customization of application programs in the MFP 100 via a network (described later in detail), validation is performed with respect to the customization requests for application programs.

The ROM updating application program 117 activated at Step S1011 uses the ROM-update-mode thread in the SCS 122 and performs rewriting/writing of the contents in the flash ROM 304.

For that, the ROM updating application program 117 uses the control services of the SCS 122 and the MCS 125. More particularly, the ROM updating application program 117 uses the ROM-update-mode thread and stores the update data in the HDD 103 or a flash card 307, or the update data provided by the module data providing server 401 via the network 400 into an update data area in a SDRAM 303. The update data area is allocated by the MCS 125.

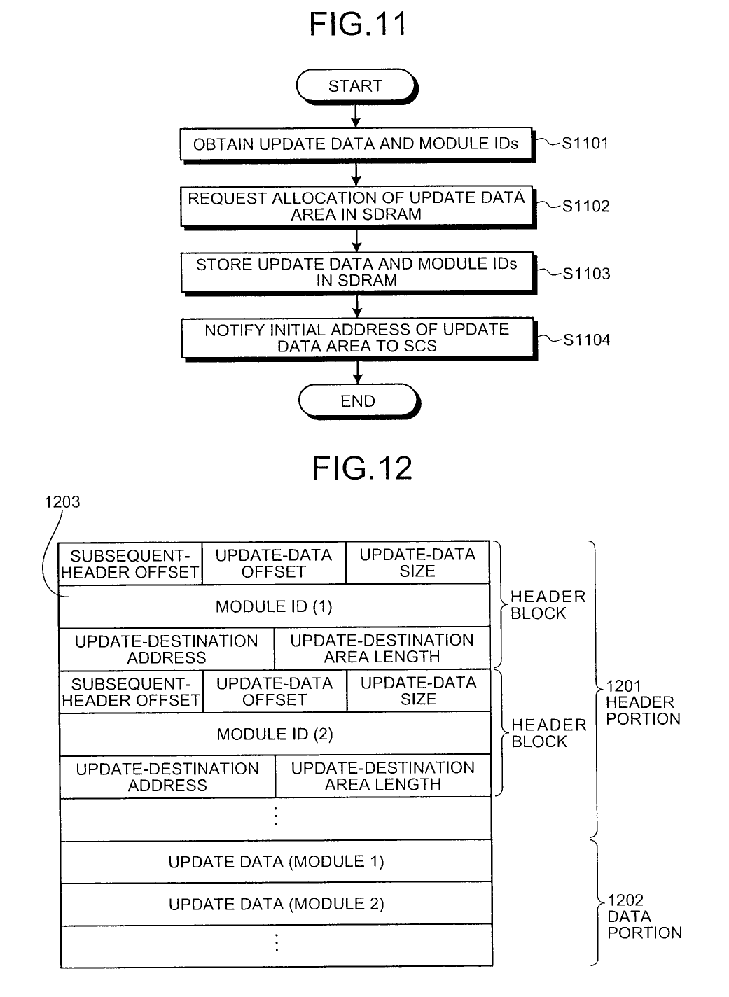

FIG. 11 is a flowchart for explaining the process by which the ROM updating application program 117 stores the update data. During that process, because the MFP 100 is functioning in the ROM update mode, it is possible to perform ROM update with respect to the control services and the application programs.

First, the data obtaining unit 151 in the ROM updating application program 117 obtains the update data. More particularly, the data obtaining unit 151 reads the update data stored in the HDD 103 or the flash card 307, or receives the update data from the module data providing server 401 via the network 400 (Step S1101).

In addition to the update data, the data obtaining unit 151 also reads/receives module IDs of modules (or sub-module IDs of sub-modules) that are to be updated.

Then, the storing unit 152 in the ROM updating application program 117 requests the MCS 125 to allocate an update data area in the SDRAM 303 for storing the update data of an update data file (Step S1102). Upon receiving the request, the ROM-update-mode thread in the MCS 125 allocates the update data area in the SDRAM 303, and sends the initial address and the size of the update data area to the ROM updating application program 117.

Subsequently, the storing unit 152 opens the update data of an update data file from the initial address of the update data area in the SDRAM 303 (Step S1103). During that process, the storing unit 152 removes network information (e.g., destination network address or packet length) not required in data update from the received update data file and stores in a referable manner only the necessary data for update in the update data area in the SDRAM 303.

FIG. 12 is a diagram of an exemplary update data area in which the ROM updating application program 117 stores update data. As shown in FIG. 12, the update data area includes a header portion 1201 and a data portion 1202. The header portion 1201 is used to store a header block for each module to be updated. Each header block includes a subsequent-header offset that is an offset for the subsequent header block, an update-data offset that is an offset for the update data corresponding to the current module, update-data size, a module ID 1203 that is the identification information of the current module, an update-destination address that is a relative address of the current module in the flash ROM 304, and an update-destination area length that is the size of the current module.

Herein, a module indicates a control service program in the MCS 125, the ECS 124, or the NCS 128; an application program in the printing application program 111 or the copying application program 112; and an engine program of a printer engine (such as the B&W LP 101 or the color LP 102) or a scanner engine. Such programs are configured to be updatable.

The read/received update data is a compressed binary data of modification programs corresponding to the abovementioned modules. While opening the compressed update data in the SDRAM 303, the ROM updating application program 117 expands the update data.

The module ID 1203 in the header portion 1201 can also be used to store, apart from the module ID, a sub-module ID as the identification information of a sub-module. The data portion 1202 is used to store the contents of the update data for each module (or each sub-module). Thus, the update data area is configured to store the update data for each module (or each sub-module) in a distinguishable manner.

The starting position of the update data for each module (or each sub-module) can be determined by referring to the update-data offset in the header block corresponding to each module (or each sub-module).

Reverting to FIG. 11, the notifying unit 153 in the ROM updating application program 117 notifies the SCS 122 of the initial address of the update data area in the SDRAM 303 in which the update data in the update data file is stored (Step S1104). Subsequently, the ROM-update-mode thread in the SCS 122 starts the process of selecting the update data.

That is, the ROM-update-mode thread in the SCS 122 refers to the update data area in the SDRAM 303 and selects the update data according to the configuration of the MFP 100.

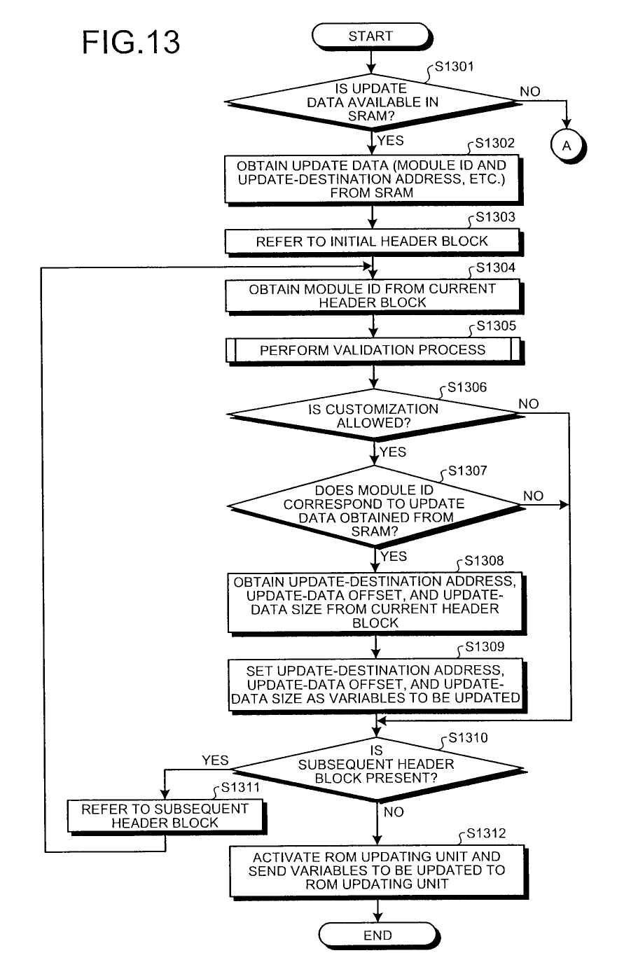

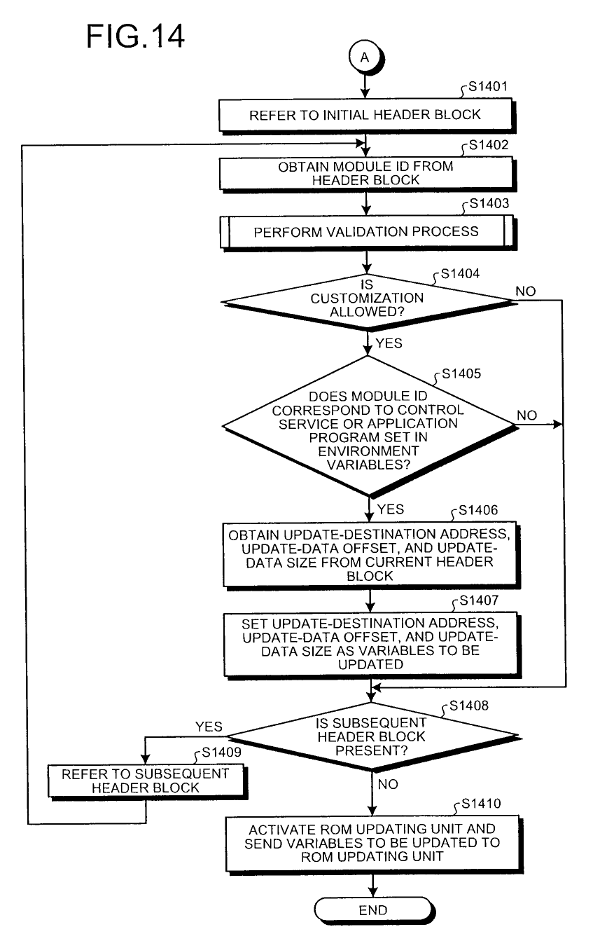

FIGS. 13 and 14 are flowchart for explaining the process by which the ROM-update-mode thread in the SCS 122 selects the update data and issues a ROM updating command.

First, the ROM-update-mode thread in the SCS 122 checks whether module ID data or update data in the SDRAM 303 (module ID, version information, update-destination address, update-data offset, and update-data size) is available in the SRAM 306 (Step S1301). More particularly, the update data is written in the SRAM 306 from the flash ROM 304 at the start of the process of ROM update. That update data is sequentially read from the SRAM 306 for performing ROM update. If the process of ROM update is interrupted, then unprocessed update data remains stored in the SRAM 306.

When it is determined that the update data is available in the SRAM 306 (Yes at Step S1301), then the ROM-update-mode thread in the SCS 122 determines that the process of ROM update has restarted after interruption and obtains the update data from the SRAM 306 (Step S1302).

Subsequently, the ROM-update-mode thread in the SCS 122 refers to the initial header block in the SDRAM 303 (Step S1303).

The ROM-update-mode thread in the SCS 122 then obtains the module ID from the current header block (Step S1304) and outputs the module ID to the CCS 130.

The CCS 130 performs validation of the module identified by the received module ID (Step S1305) and stores the validation result in a validation file. The validation process is described later in detail.

The ROM-update-mode thread in the SCS 122 then refers to the validation file and, based on the validation result, determines whether to allow customization of the corresponding module (Step S1306). When it is determined not to allow customization (No at Step S1306), the system control proceeds to Step S1310.

When it is determined to allow customization (Yes at Step S1306), the ROM-update-mode thread in the SCS 122 determines whether the module ID obtained from the current header block corresponds to the update data obtained from the SRAM 306 at Step S1302 (Step S1307).

When it is determined that the module ID obtained from the current header block corresponds to the update data obtained from the SRAM 306 (Yes at Step S1307), the ROM-update-mode thread in the SCS 122 selects the update data of that module ID from the SRAM 306 and obtains the update-destination address, the update-data offset, and the update-data size from the current header block (Step S1308).

Then, the ROM-update-mode thread in the SCS 122 sets the update-destination address, the update-data offset, and the update-data size as variables that are referred to as ‘variables subject to update’ (Step S1309).

On the other hand, when it is determined that the module ID obtained from the current header block does not correspond to the update data obtained from the SRAM 306 (No at Step S1307), the ROM-update-mode thread in the SCS 122 does not select the update data of that module ID from the SRAM 306 and the system control proceeds to Step S1310.

Subsequently, the ROM-update-mode thread in the SCS 122 refers to the subsequent-header offset of the current header block and determines whether a subsequent header block is present (Step S1310).

When it is determined that a subsequent header block is present (Yes at Step S1310), the ROM-update-mode thread in the SCS 122 refers to the subsequent header block in the SDRAM 303 (Step S1311). Subsequently, the process from Steps S1304 to S1310 is repeated with respect to the subsequent header block referred at Step S1311.

On the other hand, when it is determined that no subsequent header block is present (No at Step S1310), the ROM-update-mode thread in the SCS 122 determines that the update data corresponding to all the module IDs in the header blocks has been selected, activates the ROM updating unit 530, issues a ROM update command to the ROM updating unit 530, and sends the ‘variables subject to update’ to the ROM updating unit 530 (Step S1312).

Reverting to Step S1301, when it is determined that the update data is not stored in the SRAM 306 (No at Step S1301), the system control proceeds to Step S1401 shown in FIG. 14.

More particularly, the ROM-update-mode thread in the SCS 122 waits until the ROM updating application program 117 notifies the SCS 122 of the initial address of the update data area in the SDRAM 303. When the SCS 122 receives the initial address, the ROM-update-mode thread in the SCS 122 refers to the initial header block in the SDRAM 303 (Step S1401), obtains the module ID from that header block (Step S1402), and outputs the module ID to the CCS 130.

The CCS 130 performs validation of the module identified by the received module ID (Step S1403) and stores the validation result in a validation file. The validation process is described later in detail.

The ROM-update-mode thread in the SCS 122 then refers to the validation file and, based on the validation result, determines whether to allow customization of the corresponding module (Step S1404). When it is determined not to allow customization (No at Step S1404), the system control proceeds to Step S1408.

When it is determined to allow customization (Yes at Step S1404), the ROM-update-mode thread in the SCS 122 determines whether the module ID obtained from the current header block corresponds to a control service or an application program set in the environment variables (Step S1405).

When it is determined that the module ID obtained from the current header block corresponds to a control service or an application program set in the environment variables (Yes at Step S1405), the ROM-update-mode thread in the SCS 122 selects the update data of that module ID and obtains the update-destination address, the update-data offset, and the update-data size from the current header block (Step S1406).

Then, the ROM-update-mode thread in the SCS 122 sets the update-destination address, the update-data offset, and the update-data size as the ‘variables subject to update’ (Step S1407).

On the other hand, when it is determined that the module ID obtained from the current header block does not correspond to a control service module or an application program set in the environment variables (No at Step S1405), the ROM-update-mode thread in the SCS 122 does not select the update data of that module ID and the system control proceeds to Step S1408.

Subsequently, the ROM-update-mode thread in the SCS 122 refers to the subsequent-header offset of the current header block and determines whether a subsequent header block is present (Step S1408). When it is determined that a subsequent header block is present (Yes at Step S1408), the ROM-update-mode thread in the SCS 122 refers to the subsequent header block in the SDRAM 303 (Step S1409). Subsequently, the process from Steps S1402 to S1408 is repeated with respect to the subsequent header block referred at Step S1409.

On the other hand, when it is determined that no subsequent header block is present (No at Step S1408), the ROM-update-mode thread in the SCS 122 determines that the update data corresponding to all the module IDs in the header blocks has been selected, activates the ROM updating unit 530, issues a ROM update command to the ROM updating unit 530, and sends the ‘variables subject to update’ to the ROM updating unit 530 (Step S1410).

In this way, the update data corresponding to a module, which is validated for customization in the MFP 100, is selected from the update data stored in the update data area. Subsequently, the ROM updating unit 530 updates the flash ROM 304 with the selected update data.

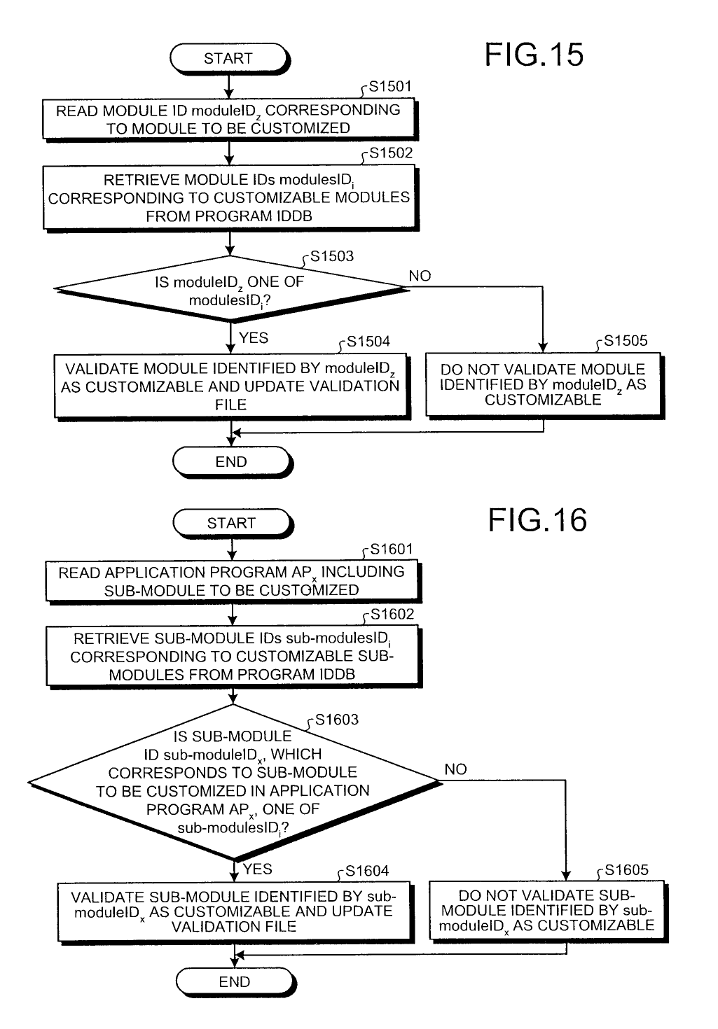

FIG. 15 is a flowchart for explaining the validation process performed by the CCS 130 at Step S1305 in FIG. 13 and Step S1403 in FIG. 14.

For the validation process, the control thread 601 in the CCS 130 generates the validation thread 602 and the XML conversion thread 603. The control thread 601 reads the validation setting information 611 and instructs the validation thread 602 to perform validation.

More particularly, first, the validation thread 602 reads a module ID moduleID_{z} that is input by the SCS 122 and that corresponds to a module to be customized (Step S1501).

Then, the validation thread 602 retrieves module IDs modulesIDᵢ, which correspond to customizable modules, from the program IDDB 612 (Step S1502).

The validation thread 602 determines whether the moduleID_{z} is one of the modulesIDᵢ (Step S1503).

When it is determined that the moduleID_{z} is one of the modulesIDᵢ (Yes at Step S1503), the validation thread 602 validates the module identified by the moduleID_{z} as customizable. The XML conversion thread 603 then adds the moduleID_{z} in the validation file 226 having the XML format (Step S1504). If the validation file 226 does not exist, then the XML conversion thread 603 creates it newly.

On the other hand, when it is determined that the moduleID_{z} is not one of the modulesIDᵢ (No at Step S1503) the validation thread 602 does not validate the module identified by the moduleID_{z} as customizable (Step S1505).

In this way, the module IDs are used for cross-checking during the validation process. Meanwhile, it is also possible to validate sub-modules by using sub-module IDs in a similar manner.

When a plurality of modules is to be customized in several batches, then only the non-customized modules can validated for customization. For that, the module IDs of the already-customized modules can be stored in the HDD 103 as update data and the modules not included in that update data can be validated for customization.

FIG. 16 is a flowchart for explaining another validation process performed by the CCS 130 by using sub-module IDs.

Generally, a module in an application program is configured from sub-modules. In the first embodiment, when an application program includes a non-customizable sub-module, then that sub-module is prevented from being customized. An example of a non-customizable sub-module is a sub-module that uses an address book containing private information. Thus, an application program including a sub-module that uses an address book can be considered to use the private information.

During the validation process, first, the validation thread 602 reads an application program APₓ that is input by the SCS 122 and that includes a sub-module to be customized (Step S1601).

Then, the validation thread 602 retrieves sub-module IDs sub-modulesIDᵢ, which correspond to customizable sub-modules, from the program IDDB 612 (Step S1602).

The validation thread 602 determines whether a sub-module ID sub-moduleIDₓ, which corresponds to the sub-module to be customized in the application program APₓ, is one of the sub-modulesIDᵢ (Step S1603).

When it is determined that the sub-moduleIDₓ is one of the sub-modulesIDᵢ (Yes at Step S1603), the validation thread 602 validates the sub-module identified by the sub-moduleIDₓ as customizable. The XML conversion thread 603 then adds the identification information of the application program APₓ and the sub-module ID sub-moduleIDₓ in the validation file 226 having XML format (Step S1604). If the validation file 226 does not exist, then the XML conversion thread 603 creates it newly.

On the other hand, when it is determined that the sub-moduleIDₓ is not one of the sub-modulesIDᵢ (No at Step S1603), the validation thread 602 does not validate the sub-module identified by the sub-moduleIDₓ as customizable (Step S1605).

In this way, during the validation process, cross-checking is performed by using sub-module IDs of sub-modules in an application program. Moreover, a sub-module using private information is not validated for customization. Such a validation process enables to validate any application program using private information for customization.

Furthermore, by registering the module IDs (or the sub-module IDs) of the modules (or the sub-modules) that use private information in the program IDDB 612, it is possible to verify whether a module (or a sub-module) to be customized is one of those registered modules (or registered sub-modules).

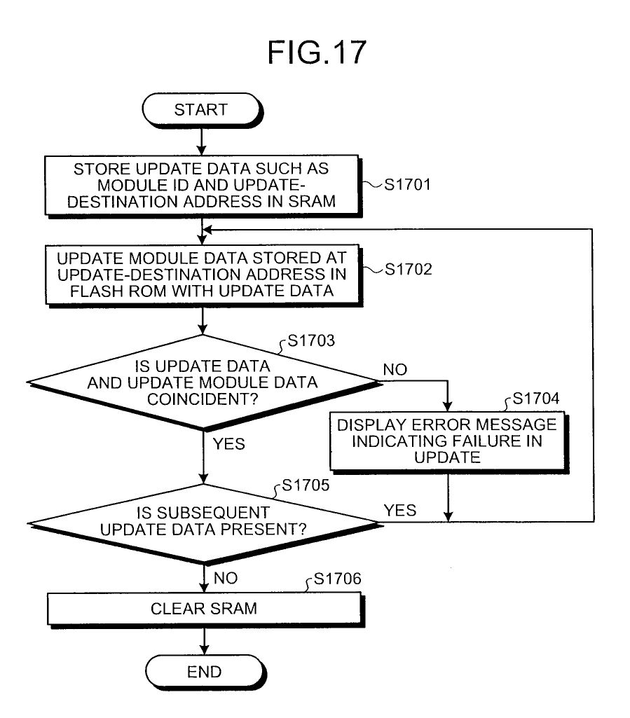

FIG. 17 is a flowchart for explaining the process by which the ROM updating unit 530 updates the flash ROM 304.

First, upon being activated by the ROM-update-mode thread in the SCS 122 and upon receiving a ROM update command from the SCS 122, the ROM updating unit 530 starts updating the flash ROM 304 with the update data. The ROM-updating-command interpreting unit 531 in the ROM updating unit 530 interprets the ROM update command.

Then, the SRAM processing unit 532 in the ROM updating unit 530 sequentially retrieves the module ID, the update-destination address, the update-data offset, and the update-data size from the ‘variables subject to update’, and stores that information in the SRAM 306 (Step S1701). Even if the process of updating the flash ROM 304 is interrupted at Step S1701 due to an error, it is possible to perform the subsequent process after reactivation of the ROM updating unit 530.

The ROM update processing unit 533 in the ROM updating unit 530 refers to the address specified in the update-data offset stored at the initial address in the SDRAM 303, reads data equivalent to the update-data size as update data, and updates the module stored at the update-destination address in the flash ROM 304 with the read update data (Step S1702).

Then, the ROM update processing unit 533 checks for the coincidence between the update data in the SDRAM 303 and updated module data in the flash ROM 304 (Step S1703).

If it is determined that the update data in the SDRAM 303 and the updated module data in the flash ROM 304 is not coincident (No at Step S1703), the display control unit 534 in the ROM updating unit 530 displays an error message indicating failure in the update process (Step S1704) and the system control returns to Step S1702.

If it is determined that the update data in the SDRAM 303 and the updated module data in the flash ROM 304 is coincident (Yes at Step S1703), the ROM update processing unit 533 determines whether the ‘variables subject to update’ include the subsequent set of the module ID, the update-destination address, the update-data offset, and the update-data size (Step S1705).

If it is determined that the ‘variables subject to update’ include the subsequent set of the module ID, the update-destination address, the update-data offset, and the update-data size (Yes at Step S1705), the ROM update processing unit 533 performs the update process from Step S1702 by using the subsequent set of the module ID, the update-destination address, the update-data offset, and the update-data size. In this way, the ROM update processing unit 533 performs the update process from Step S1702 for each set of the module ID, the update-destination address, the update-data offset, and the update-data size received from the SCS 122.

If it is determined that the ‘variables subject to update’ do not include the subsequent set of the module ID, the update-destination address, the update-data offset, and the update-data size (No at Step S1705), the SRAM processing unit 532 clears the SRAM 306 (Step S1706) and the update process is completed.

In this way, by performing the validation process, only the validated and selected modules (or sub-modules) are stored in the flash ROM 304.

That is, when the MFP 100 receives an update request from the operation panel 310 or the PC 402, the update data in the flash card 307 or the update data from the module data providing server 401 is subjected to validation and selection with respect to each module (or each sub-module), and the modules in the flash ROM 304 are updated with the validated and selected update data.

Conventionally, when a user is authorized to perform software customization, it becomes difficult to maintain the security of the classified data (e.g., private information) used by the software programs. On the contrary, in the MFP 100, it is possible to determine whether each module (or each sub-module) is customizable and prevent modules (or sub-modules) that use the classified data from being customized. That helps in securing the classified data.

Thus, in the MFP 100, it is possible to validate each module (or each sub-module) for customization. In other words, during the customization of an application program, the MFP 100 has the functionality of validating each module (or each sub-module) in the application program. As a result, it becomes possible to determine which modules (or sub-modules) are allowed to be customized thereby enhancing the security of the MFP 100.

Particularly, in the MFP 100, the module IDs (or the sub-module IDs) of the modules (or the sub-modules) that use an address book are registered in the program IDDB 612. That helps in preventing a third person from having access to the private information of the users.

Moreover, by storing the information regarding the non-customizable modules that use private information, it becomes possible to apply usage restriction to such modules. That also helps in enhancing the security of the MFP 100.

An example of private information is network addresses of the users. While using a network, a network address is equivalent to a mailing address and is particularly important to the security of the user. Thus, applying a restriction on customization of the modules (or sub-modules) that use such private information enables to enhance the security.

Moreover, because the MFP 100 is configured to perform validation locally, the validation process is performed more efficiently.

As described above, in the first embodiment, the validation thread 602 performs the local validation method. However, it is also possible to perform remote validation. Given below is the description of a remote validation method performed by a validation server according to a second embodiment of the present invention. In the second embodiment, the configuration of the MFP 100 is identical to that described in the first embodiment. Hence, that description is not repeated.

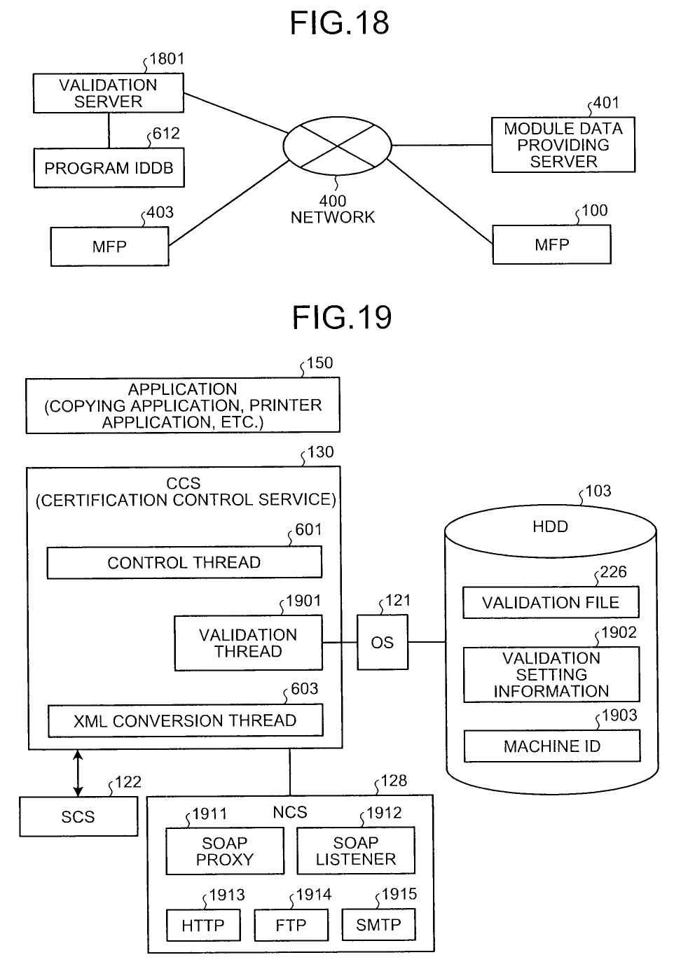

FIG. 18 is a diagram for explaining an exemplary network configuration according to the second embodiment of the network 400 to which the MFP 100 is connected. As shown in FIG. 18, a validation server 1801 is connected to the network 400.

The validation server 1801 refers to the program IDDB 612 and validates modules (or sub-modules) for customization.

FIG. 19 is a diagram for explaining a validation process performed by the CCS 130 according to the second embodiment. The process performed by the CCS 130 includes the control thread 601, a validation thread 1901, and the XML conversion thread 603. The CCS 130 performs the process of validating each module (or each sub-module) for customization, converting the validation result for each module (or each sub-module) into the XML format, and storing the validation file 226 in XML format in the HDD 103.

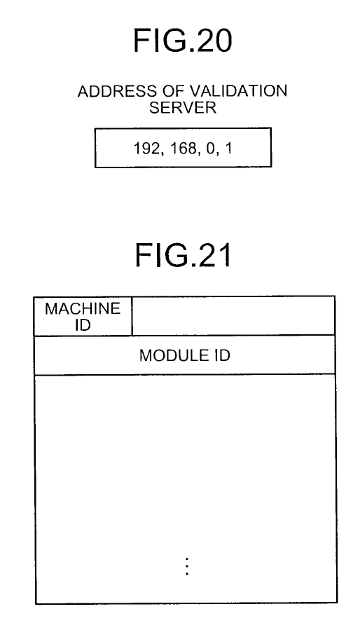

The HDD 103 is used to store the validation file 226, validation setting information 1902, and a machine ID 1903. The validation setting information 1902 includes an instruction to request validation to the validation server 1801 and the address of the validation server 1801 (see FIG. 20). The machine ID 1903 is used to identify the MFP 100.

When the validation thread 1901 refers to the validation setting information 1902, it obtains the instruction to request validation to the validation server 1801 and the address of the validation server 1801. Then, the validation thread 1901 accesses the validation server 1801 and requests it to perform validation. For that, the validation thread 1901 sends the machine ID 1903 in the HDD 103 and a module ID (or a sub-module ID) of the module (or the sub-module) to be customized to the validation server 1801 by using the NCS 128.

The validation server 1801 then cross-checks the received module ID (or received sub-module ID) with the module ID (or the sub-module ID) registered in the program IDDB 612 corresponding to the machine ID, performs validation of the corresponding module (or corresponding sub-module), and sends the validation result to the validation thread 1901 in the MFP 100. Meanwhile, the validation process performed by the validation thread 1901 is identical to the validation process described with reference to FIG. 16.

In this way, the validation of modules (or sub-modules) can also be performed in the validation server 1801 connected to the MFP 100 via the network 400. Such a configuration enables to perform more secured validation.

Before the validation thread 1901 requests the validation server 1801 to perform validation, the XML conversion thread 603 converts the validation request into XML format and generates a SOAP message. On the other hand, when the validation server 1801 sends a SOAP message including the validation result, the XML conversion thread 603 converts the SOAP message from XML format to a format recognizable by the validation thread 1901 and sends the validation result to the validation thread 1901. In this way, the validation server 1801 and the MFP 100 communicate in the form of SOAP messages.

More particularly, the NCS 128 is used to perform SOAP message communication. For that, the NCS 128 includes a SOAP proxy 1911, a SOAP listener 1912, a hypertext transfer protocol (HTTP) service providing thread 1913, a file transfer protocol (FTP) service providing thread 1914, and a simple mail transfer protocol (SMTP) service providing thread 1915.

The SOAP proxy 1911 functions as a message transmitting unit, includes the validation file 226 in XML format, and generates a SOAP message for transmission in which a uniform resource identifier (URI) is specified for a destination SOAP server such as another MFP, a PC, or an administrative server over the network.

The SOAP proxy 1911 generates a SOAP message to the address specified in the SOAP message. In the second embodiment, the destination for SOAP message transmission is set to the validation setting information 1902.

The SOAP listener 1912 functions as a message receiving unit that receives and interprets a SOAP message, and sends the interpreted SOAP message to other control services or application programs. More particularly, the SOAP listener 1912 selects the destination for an interpreted SOAP message and sends the interpreted SOAP message to the selected destination or notifies the selected destination that receiving the SOAP message.

FIG. 21 is a diagram of an exemplary data structure of the data in a SOAP message generated for transmission by the SOAP proxy 1911. In FIG. 21, only the data structure is shown and the other portion such as XML tags is not shown. As shown in FIG. 21, the body of the SOAP message includes a machine ID and a module ID (or a sub-module ID) to which the validation server 1801 can refer during validation.

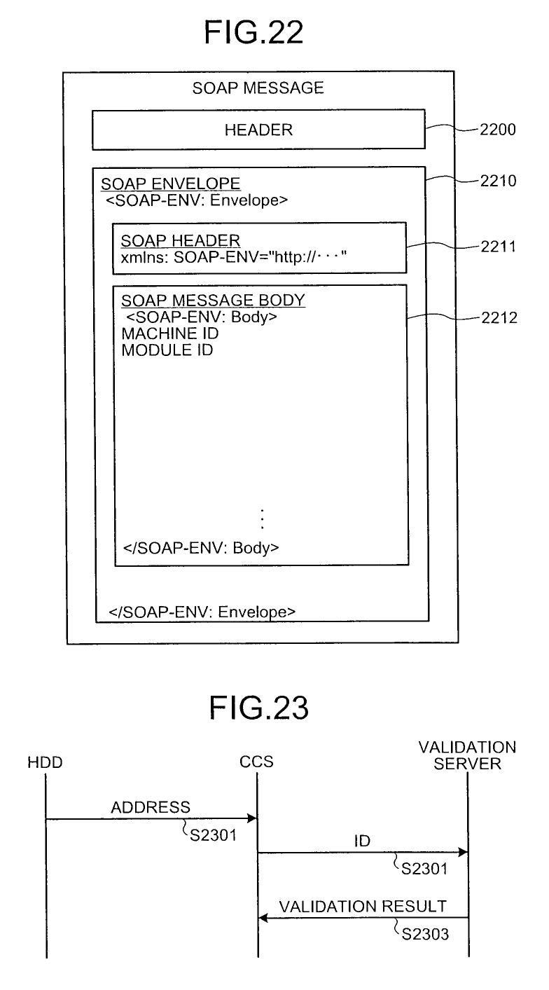

FIG. 22 is a diagram of an exemplary structure of a SOAP message generated by the SOAP proxy 1911. As shown in FIG. 22, the SOAP message includes a header 2200 and a SOAP envelope 2210, which further includes a SOAP header 2211 and a SOAP message body 2212.

In the SOAP header 2211, the URI of a destination for the SOAP message is specified. In the SOAP message body 2212, the data shown in FIG. 21 is inserted in XML format as elements of a <SOAP-ENV: Body> tag.

FIG. 23 is a sequence diagram for explaining a sequence in which the validation server 1801 performs the validation process.

First, the CCS 130 reads the address of the validation server 1801 from the validation setting information 611 stored in the HDD 103 (Step S2301).

Then, the CCS 130 uses the address of the validation server 1801 to send thereto the machine ID of the MFP 100 and a module ID (or a sub-module ID) of the module (or a sub-module) to be customized (Step S2302).

The validation server 1801 then cross-checks the received module ID (or received sub-module ID) with the module ID (or the sub-module ID) registered in the program IDDB 612 corresponding to the received machine ID, performs validation of the corresponding module (or the corresponding sub-module), and sends the validation result to the CCS 130 (Step S2303).

Thus, because the CCS 130 receives the validation result from the validation server 1801, it can perform customization of the module (or the sub-module) based on the validation result.

According to the second embodiment, the MFP 100 is configured to be customized from a PC via the network 400. Moreover, the validation for customization can be performed at the validation server 1801. That enables to remotely control the MFP 100.

Moreover, by requesting the validation server 1801 connected to the MFP 100 via the network 400 to perform validation, a more objective validation result can be achieved.

In this way, according to an aspect of the present invention, it is possible to enhance software security of an image processing apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a module to be customized;
an identification-information obtaining unit that obtains identification information for identifying the module;
a validating unit that validates, based on validation information including information indicating whether to allow a customization for a module identified by the identification information, whether the module identified by the identification information is customizable; and
a control unit that, when the validating unit validates that the module identified by the identification information is customizable, performs the customization of the module identified by the identification information.

2. The image processing apparatus according to claim 1, further comprising a memory unit that stores therein the validation information, wherein
the validating unit validates whether the module identified by the identification information is customizable based on the validation information stored in the memory unit.

3. The image processing apparatus according to claim 1, wherein the validating unit validates whether the module identified by the identification information is customizable by issuing a validation request to a validating device that possesses the validation information connected to the image processing apparatus via a network and obtaining a validation result form the validating device.

4. The image processing apparatus according to claim 1, wherein
the module includes a sub-module,
the identification information is used to further identify the sub-module,
the validating unit further validates whether the sub-module identified by the identification information is customizable, and
the control unit performs the customization of the module in units of sub-modules.

5. The image processing apparatus according to claim 1, further comprising an update-data obtaining unit that obtains update data for each module to be customized, wherein
the control unit updates the module by using obtained update data in units of modules.

6. The image processing apparatus according to claim 1, wherein the validation information includes information indicating that the customization is not allowed for a module that uses private information.

7. The image processing apparatus according to claim 1, wherein the identification-information obtaining unit obtains the identification information from an information processing device connected to the image processing apparatus via a network.

8. An image processing method comprising:
obtaining identification information for identifying a module to be customized;
validating, based on validation information including information indicating whether to allow a customization for a module identified by the identification information, whether the module identified by the identification information is customizable; and
performing, when the module identified by the identification information is validated to be customizable at the validating, the customization of the module identified by the identification information.

9. A computer program product comprising a computer-usable medium having computer-readable program codes embodied in the medium that when executed cause a computer to execute:
obtaining identification information for identifying a module to be customized;
validating, based on validation information including information indicating whether to allow a customization for a module identified by the identification information, whether the module identified by the identification information is customizable; and
performing, when the module identified by the identification information is validated to be customizable at the validating, the customization of the module identified by the identification information.
